(19) United States
(12) Patent Application Publication
(10) Pub. No.: US 2025/0376425 A1
(43) Pub. Date: Dec. 11, 2025

(54) FERTILIZER COMPOSITION CONTAINING A CARBON-BASED ADDITIVE AND METHODS OF MAKING SAME

(71) Applicant: The Mosaic Company, Tampa, FL (US)

(72) Inventors: Jerri Light, Regina (CA); Addison Richards, Regina (CA)

(21) Appl. No.: 19/171,664

(22) Filed: Apr. 7, 2025

Related U.S. Application Data
(60) Provisional application No. 63/657,576, filed on Jun. 7, 2024.

(51) Int. Cl. C05D 1/00; C05B 19/00; C05G 5/16; C05G 5/30

(52) U.S. Cl. CPC C05D 1/00; C05B 19/00; C05G 5/16; C05G 5/30

(57) ABSTRACT

A macro-nutrient or mineral fertilizer product including a plurality of fertilizer particles, each including a fertilizer carrier, such as an N/P/K fertilizer, that incorporates a carbon-based additive to enhance particle quality. The carbon-based additive can have a functionalized or activated surface, such as a carbon-black acid with carboxyl groups at its surface. The functionalized surface can react with nutrients in a soil environment in which its dispersed, or both, to enhance the ability for the nutrients to be taken up by a plant. In one example, the carbon-based additive is a dry additive, such as powdered or particulates of carbon-black acid that is incorporated into the fertilizer carrier composition.

### RELATED APPLICATIONS

The present application claims the benefit of U.S. Provisional Application Ser. No. 63/657,576, filed Jun. 7, 2024, which is hereby incorporated by reference in its entirety.

### TECHNICAL FIELD

The present disclosure relates generally to fertilizer, and more specifically to a fertilizer product with a carbon-based additive such as carbon black acid.

### BACKGROUND

Fertilizers can be used to deliver nutrients to plants and the surrounding soil to grow healthier and stronger crops. Fertilizers generally include a macronutrient such as potassium, phosphorus, nitrogen, or combinations thereof (“N/P/K”). Potassium fertilizers, or potash, for example, can be used to provide potassium to plants when the soil is unable to provide the optimal amount. Potash is a general term used to describe a variety of potassium-containing agricultural fertilizers. The fertilizers can be spread onto the soil surface prior to tilling and planting crops and can be later added during plant growth depending on the crop need. The potassium then dissolves into the soil, where it can promote plant growth by providing needed nutrients to the plant.

Fertilizers are generally produced by a number of well-known processes including, but not limited to, granulation and compaction. For example, wet granulation is a process in which a fertilizer composition, such as a slurry of a phosphate-containing materials, enters a drum, such as a rotary drum granulator in which the slurry rolls and solidifies, and then is granulated into fertilizer particles. Optionally, other additives, such as secondary nutrients or micronutrients, can be added during the formation of the slurry and/or in the rotary drum as the particles are being formed. In addition, as in the example of a phosphate composition containing ammonia phosphate, ammonia can be added (e.g. sparging) to the rotary drum to control the ammonia/phosphate ratio. An example of a granulation process is described, for example, in U.S. Pat. No. 6,544,313, incorporated herein by reference in its entirety.

Compaction is a process that can be utilized to create fertilizer granules from fine, dry particles. Fertilizer compaction usually involves subjecting the fine, dry fertilizer particles to a high-pressure environment, such as a high-pressure roller, such that the fine particles are compressed into sheets or flakes. The sheets or flakes are then broken into smaller granules of the desired size. An example of a compaction process for forming a potash fertilizer is described, for example, in U.S. Pat. No. 7,727,501, incorporated herein by reference in its entirety. Fertilizers can be used to improve plant health by providing nutrients to the plant, but other benefits may be desired.

It can be advantageous for a fertilizer to enhance the yield response of the crop. Additionally, in some situations, it may be desired to minimize fertilizer usage. Among other reasons, reducing fertilizer usage can reduce operational costs. It would thus be advantageous for a fertilizer to enhance the nutrient use efficiency, which can result in the same nutrient delivery, but with less fertilizer required. Further, in some geographic areas, severe weather is becoming increasingly common and can subject plants to high-stress environments resulting from drought, heat, storms, or nutrient deficiency to name a few. It would be further advantageous for a fertilizer to allow plants to better cope with and mitigate these high-stress environments. Further still, due to geographic location or overharvested land, soil health can become deteriorated. It would be advantageous for fertilizer granules to improve the health of the soil and promote microbial activity in the localized soil region around the granule. Better particle quality metrics of fertilizer particles to reduce or minimize particle degradation and the production of dust during storage, transportation, and handling can help to accomplish these goals.

### SUMMARY

The present disclosure generally describes a macro-nutrient or mineral fertilizer product including a plurality of fertilizer particles, each including a fertilizer carrier, such as an N/P/K fertilizer, that incorporates a carbon-based additive to enhance particle quality. The carbon-based additive can have a functionalized or activated surface (i.e. contains active or functional groups on the surface), such as, for example, carbon-black acid having hydroxyl or carboxyl groups at its surface. The functional groups can react with the macro-, secondary-, and/or micronutrients of the underlying carrier composition, can react with nutrients in a soil environment in which its dispersed, or both, to enhance the ability for the nutrients to be taken up by a plant. In an alternative embodiment, the carbon-based additive does not include a functionalized or activated surface, such as, for example, but not limited to, biochar, starches, carbon black, humics, fulvics, and the like, or combinations thereof. In yet another embodiment, the carbon-based additive includes a combination of additives having a functionalized or activated surface and additives without a functionalized or activated surface.

In one non-limiting example, the carbon-based additive is a dry additive, such as a powder or particles of a carbon-black acid, or other carbon-based additive. In embodiments, the carbon-based additive can have a particle size in a range of, for example, but not limited to, from about 120 nanometers (nm) to about 500 microns (μm). In alternative embodiments, the carbon-based additive is in a liquid form, such as a syrup. In yet other embodiments, the carbon-based additive is a combination of liquid and powder form, such as a dry powder form incorporated into and/or onto a fertilizer carrier, and a liquid form incorporated into and/or onto the fertilizer carrier.

The fertilizer carrier can include, for example, a potassium-containing or potash fertilizer such as, but not limited to, potassium chloride (KCl), muriate of potash (MOP), sulfate of potash, sulfate of potash-magnesia, potassium nitrate, potassium hydroxide, langbeinite (potassium magnesium sulfate), polyhalite (K₂Ca₂Mg(SO₄)₄:2H₂O), etc., a phosphate fertilizer such as, but not limited to, monoammonium phosphate (MAP), sulfur fortified MAP (e.g., MicroEssentials®) diammonium phosphate (DAP), single superphosphate, triple superphosphate, struvite, etc., a nitrogen fertilizer such as, but not limited to, urea, nitrates or combinations thereof, or other macro-fertilizers such as, but not limited to, kieserite, or any combination thereof. The fertilizer may further include any of a variety or combinations of sulfates calcium sulfate, magnesium sulfate, and ammonium sulfate, secondary nutrients including calcium, magnesium, and sulfur (as elemental sulfur and/or sulfate sulfur), and/or micronutrients including zinc, manganese, iron, copper, molybdenum, boron, chloride, cobalt, and sodium.

The carbon-based additive can be present in an amount of about from about 0.01-5 wt % of the total weight of the fertilizer particle, or more particularly, from about 0.05-1 wt % of the fertilizer particle. The carbon-based additive, whether in solid or liquid form, can be incorporated into the fertilizer particle itself, can be coated thereon, or can be a combination of both.

The fertilizer particles can be manufactured by any conventional means including wet granulation, dry granulation, compaction, chemical production, or any suitable method known to one of ordinary skill in the art. The carbon-based additive can be incorporated into the process stream at any point, such as in a rotary granulation drum, in formation of a fertilizer composition slurry, mixed in with particle fines in a compaction process, etc., depending on the method of production. The inclusion rate of the carbon-based additive can vary from about 0.01-5 wt %, or more particularly, from about 0.05-1% of the fertilizer. The fertilizer with a carbon-based additive can have several benefits when used to grow crops, including enhanced yield response, enhanced nutrient use efficiency, improved stress mitigation response, improved soil health, and/or triggered microbial activity.

In some non-limiting examples, a potash fertilizer is co-compacted with a carbon-based additive and can comprise white and/or red potash. Further, in some implementations, the inclusion rate of the carbon-based additive can vary between 0.1-1% of the potash. Further still, in some implementations the carbon-based additive can include varying percentages of pre-loaded micronutrients.

The summary above is not intended to describe each illustrated example or every implementation of the present disclosure. The figures and the detailed description that follow more particularly exemplify these examples.

### BRIEF DESCRIPTION OF THE DRAWINGS

Subject matter hereof may be more thoroughly understood in consideration of the following detailed description of various examples in connection with the accompanying figures, in which:

FIG. 1 shows a powdered, carbon-based additive (carbon black acid) with no preloaded micronutrients.

FIG. 2 shows white potash and white potash compacted with 0.1-1% inclusion rates of a carbon-based additive with no preloaded micronutrients.

FIG. 3 shows red potash compacted with a 0.05% inclusion rate of a carbon-based additive with no preloaded micronutrients.

FIG. 4 shows red potash compacted with a 0.25% inclusion rate of a carbon-based additive with no preloaded micronutrients.

FIG. 5 shows red potash compacted with a 0.1% inclusion rate of a carbon-based additive with no preloaded micronutrients.

FIG. 6 shows red potash compacted with a 0.5% inclusion rate of a carbon-based additive with no preloaded micronutrients.

While various examples are amenable to various modifications and alternative forms, specifics thereof have been shown by way of example in the drawings and will be described in detail. It should be understood, however, that the intention is not to limit the claimed inventions to the particular examples described. On the contrary, the intention is to cover all modifications, equivalents, and alternatives falling within the spirit and scope of the subject matter of the present disclosure.

### DETAILED DESCRIPTION

Before turning to the figures, which illustrate certain examples in detail, it should be understood that the present disclosure is not limited to the details or methodology set forth in the description or illustrated in the figures. It should also be understood that the terminology used herein is for the purpose of description only and should not be regarded as limiting.

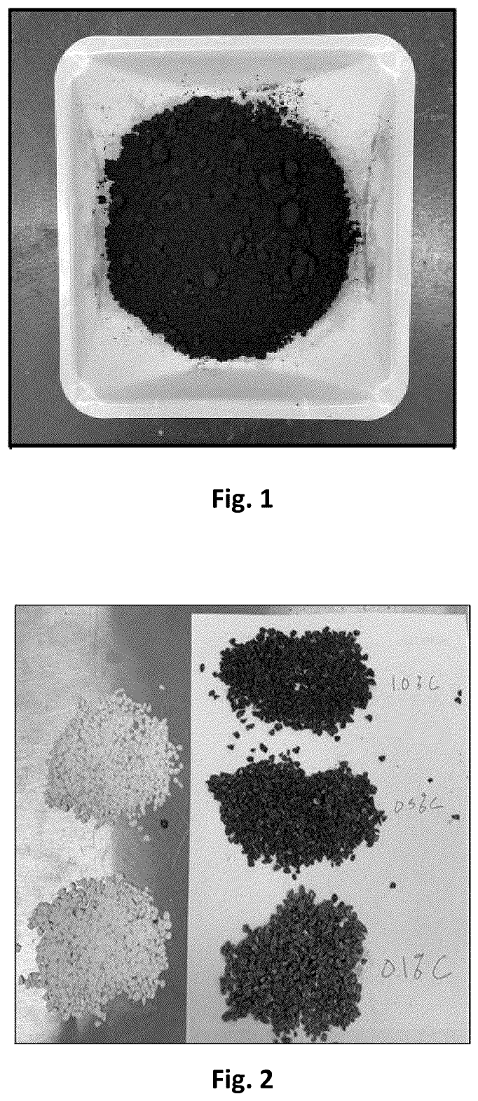

FIG. 1 shows a powdered, carbon-based additive having a functionalized surface, and more specifically, carbon black acid. As mentioned, the carbon-based additive can have a functionalized or activated surface (i.e. contains active or functional groups on the surface such as carboxyl and/or hydroxyl groups). The functional groups can react with the macro-, secondary-, and/or micronutrients of the underlying carrier composition, can react with nutrients in a soil environment in which its dispersed, or both, to enhance the ability for the nutrients to be taken up by a plant, so as to enhance yield response, enhance nutrient use efficiency, improve stress mitigation response, improve soil health, trigger microbial activity, or any combination thereof.

Examples of carbon-based additives include carbon black acids sourced from the incomplete combustion of materials including vegetable matter or other organic matter, or petroleum products, that are oxidized by controllable chemical oxidation to create the functional groups on its surface. In one non-limiting embodiment, the carbon-based additive comprises carbon black acid having carboxyl groups at its surface.

In alternative embodiments (not shown), the carbon-based additive does not include a functionalized or activated surface, such as, for example, but not limited to, biochar, starches, carbon black, humics, fulvics, and the like, or combinations thereof. In yet other embodiments, the carbon-based additive includes a combination of additives having a functionalized or activated surface and additives without a functionalized or activated surface.

In non-limiting examples, the carbon-based additive is a dry additive, such as a powder or particles of a carbon-black acid. The carbon-based additive can have a particle size in a range of, for example, but not limited to, from about 120 nanometers (nm) to about 500 microns (μm), and more particularly, from about 120 nm to about 1 μm, from about 1 μm to about 500 μm, from about 20 um to about 300 μm, or from about 50 μm to about 100 μm. Other subranges within the range of from about 120 nanometers (nm) to about 500 microns (μm) may also be contemplated. In alternative embodiments, the carbon-based additive is in a liquid form, such as a syrup. In yet other embodiments, the carbon-based additive is a combination of liquid and powder form, such as a dry powder form incorporated into and/or onto a fertilizer carrier, and a liquid form incorporated into and/or onto the fertilizer carrier.

The carbon-based additive can be combined with a fertilizer composition as described above, including a potassium-containing or potash fertilizer such as, but not limited to, potassium chloride (KCl), muriate of potash (MOP), sulfate of potash, sulfate of potash-magnesia, potassium nitrate, potassium hydroxide, langbeinite (potassium magnesium sulfate), polyhalite (K₂Ca₂Mg(SO₄)₄:2H₂O), etc., a phosphate fertilizer such as, but not limited to, monoammonium phosphate, diammonium phosphate, single superphosphate, triple superphosphate, struvite, etc., or any combination thereof, with or without sulfates, secondary nutrients and/or micronutrients. The carbon-based additive can be incorporated into a granulation process, compaction process, chemical process, electrostatic coating, or any process known to one of ordinary skill in the art for producing fertilizer granules, or combinations thereof (e.g., incorporated into and/or onto the granule).

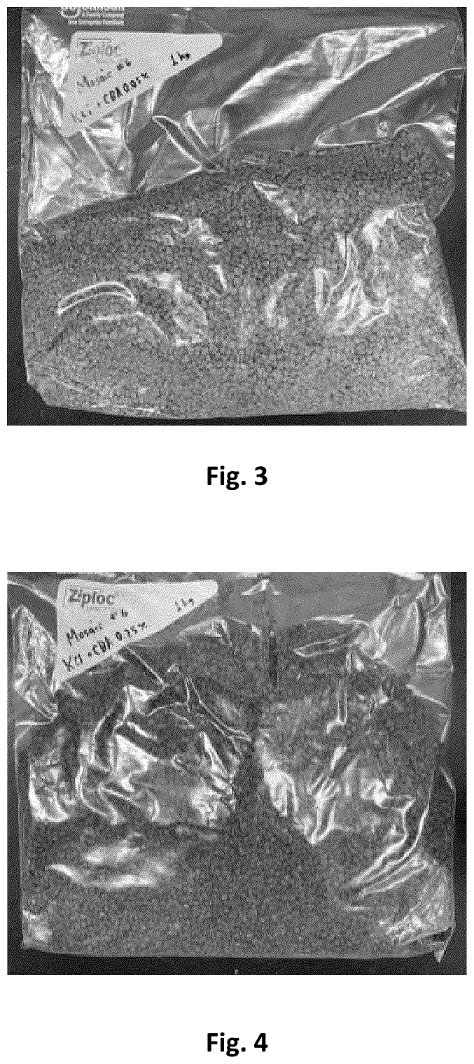

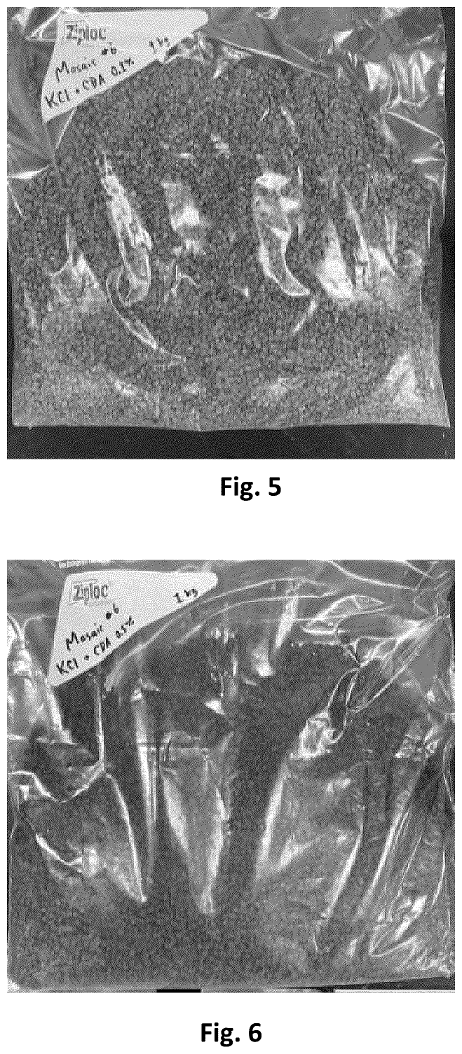

In non-limiting examples, the carbon-based additive having a functionalized surface is mixed with red and/or white potash and compacted to create co-compacted granules as shown in FIGS. 2-6. Using the carbon-based additive with white and/or red potash can result in co-compacted potash granules having increased capabilities. Co-compacted potash granules with carbon-based additives can, among other benefits, enhance yield response in crops, enhance nutrient use efficiency, improve stress mitigation responses, improve health of soil in the localized region around the granule, and trigger microbial activity in the localized region around the granule.

In some implementations, the carbon-based additive includes pre-loaded micronutrients. The preloaded micronutrients can create additional benefits for the plants and soil such as further increasing yield response. The preloaded micronutrients can be comprised of boron, zinc, manganese, or other micronutrients, either alone or in combination with one another. Additionally, the micronutrients can comprise varying percentages of the carbon-based additive.

In examples shown in FIGS. 2-6, the fertilizer with the carbon-based additive comprises co-compacted potash granules. To create the co-compacted potash fertilizer with the carbon-based additive, the carbon-based additive is mixed with fine potash particles. The fine potash particles can be white and/or red potash, and as previously mentioned, the carbon-based additive can further include one or a combination of micronutrients. The mixed potash particles and carbon additives are then exposed to high pressure, where they are co-compacted to form a sheet or flakes. The sheet or flakes are then broken into smaller pieces to create the granules shown in FIGS. 2-6.

The co-compacted potash fertilizer with carbon-based additives can be comprised of various inclusion rates of the powdered carbon-based additive. In exemplary implementations, the inclusion rate of the carbon-based additive comprises about 0.01-5 wt % of the total weight of the fertilizer particle, and more particularly, about 0.1-1 wt % of the potash fertilizer. However, it should be appreciated that the inclusion rate of the carbon-based additive can be increased or decreased to achieve desired effects on the co-compacted potash fertilizer.

It should be understood that the individual operations used in the methods of the present teachings may be performed in any order and/or simultaneously, as long as the teaching remains operable. Furthermore, it should be understood that the apparatus and methods of the present teachings can include any number, or all, of the described examples, as long as the teaching remains operable.

Various examples of systems, devices, and methods have been described herein. These examples are given only by way of example and are not intended to limit the scope of the claimed inventions. It should be appreciated, moreover, that the various features of the examples that have been described may be combined in various ways to produce numerous additional examples. Moreover, while various materials, dimensions, shapes, configurations and locations, etc. have been described for use with disclosed examples, others besides those disclosed may be utilized without exceeding the scope of this disclosure.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood by persons of ordinary skill in the art. Moreover, elements described with respect to one example can be implemented in other examples even when not described in such examples unless otherwise noted.

Although a dependent claim may refer in the claims to a specific combination with one or more other claims, other examples can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A fertilizer product comprising a plurality of fertilizer granules, each granule comprising:
a fertilizer carrier composition; and
a carbon-based additive having functional groups.

2. The fertilizer product of claim 1, wherein the carbon-based additive comprises carbon black acid, and the functional groups comprise carboxyl groups.

3. The fertilizer product of claim 1, wherein the functional groups comprise hydroxyl groups.

4. The fertilizer product of claim 1, wherein the fertilizer carrier composition comprises a potassium-containing composition.

5. The fertilizer product of claim 4, wherein the potassium-containing composition is selected from the group consisting of potassium chloride, muriate of potash, sulfate of potash, sulfate of potash-magnesia, potassium nitrate, potassium hydroxide, langbeinite, polyhalite, and combinations thereof.

6. The fertilizer product of claim 1, wherein the fertilizer carrier composition comprises a phosphate-containing composition.

7. The fertilizer product of claim 6, wherein the phosphate-containing composition is selected from the group consisting of monoammonium phosphate, sulfur-fortified monoammonium phosphate diammonium phosphate, single superphosphate, triple superphosphate, struvite, and combinations thereof.

8. The fertilizer product of claim 1, wherein the carbon-based additive is dispersed within the fertilizer carrier composition.

9. The fertilizer product of claim 1, wherein the carbon-based additive is formed as a coating on an external surface of the fertilizer particles.

10. The fertilizer product of claim 1, wherein the carbon-based additive is present in an amount in a range of from about 0.01 wt % to about 5 wt % of the total weight of the fertilizer particle.

11. The fertilizer product of claim 1, wherein the carbon-based additive comprises dry particles having an average particle size in a range of from about 120 nm to about 500 μm.

12. The fertilizer product of claim 1, wherein the carbon-based additive comprises a liquid.

13. A fertilizer product comprising a plurality of fertilizer granules, each granule comprising:
a fertilizer carrier composition; and
a plurality of carbon black acid particles having an average particle size in a range of from about 120 nm to about 500 μm.

14. The fertilizer product of claim 13, wherein the fertilizer carrier composition comprises a potassium-containing composition.

15. The fertilizer product of claim 14, wherein the potassium-containing composition is selected from the group consisting of potassium chloride, muriate of potash, sulfate of potash, sulfate of potash-magnesia, potassium nitrate, potassium hydroxide, langbeinite, polyhalite, and combinations thereof.

16. The fertilizer product of claim 13, wherein the fertilizer carrier composition comprises a phosphate-containing composition.

17. The fertilizer product of claim 16, wherein the phosphate-containing composition is selected from the group consisting of monoammonium phosphate, sulfur-fortified monoammonium phosphate, diammonium phosphate, single superphosphate, triple superphosphate, struvite, and combinations thereof.

18. The fertilizer product of claim 13, wherein the plurality of carbon black acid particles are dispersed within the fertilizer carrier composition.

19. The fertilizer product of claim 13, wherein the plurality of carbon black acid particles is present in an amount in a range of from about 0.01 wt % to about 5 wt % of the total weight of the fertilizer particle.

20.-24. (canceled)

25. The fertilizer product of claim 1, wherein the fertilizer carrier composition comprises a nitrogen-containing composition.

26. The fertilizer product of claim 13, wherein the fertilizer carrier composition comprises a nitrogen-containing composition.
